(19) United States
(12) Patent Application Publication
(10) Pub. No.: US 2018/0036927 A1
(43) Pub. Date: Feb. 8, 2018

(54) INJECTION MOULDING MACHINE FOR PRODUCING A MULTIPLICITY OF DIFFERENT INJECTION MOULDINGS

(71) Applicant: PHOENIX CONTACT GmbH & Co. KG, Blomberg (DE)

(72) Inventor: Ralf GRAEBEL, Aerzen (DE)

(21) Appl. No.: 15/668,851

(22) Filed: Aug. 4, 2017

(30) Foreign Application Priority Data
Aug. 5, 2016 (DE) 102016214589.4

(51) Int. Cl. B29C 45/33

(52) U.S. Cl. CPC B29C 45/33; B29C 2045/2689

(57) ABSTRACT

An injection moulding machine used for producing a multiplicity of different injection mouldings includes a first injection mould half and a second injection mould half each having a multiplicity of partial cavities. In a closed position of the injection moulding machine, the partial cavities of the first injection mould half, together with corresponding partial cavities of the second injection mould half, form at least a multiplicity of different mould cavities corresponding to the multiplicity of injection mouldings to be produced, each of said cavities having an injection opening. The first and second injection mould halves are movable relative to an injection unit of the injection moulding machine along a second motion axis, wherein the second motion axis is perpendicular to a first motion axis, along which the injection mould halves are movable towards one another in the direction of the closed position and away from one another in the direction of an open position. The at least one first outlet opening of the injection unit can be brought into fluid communication with each injection opening of each mould cavity by moving the first and second injection mould halves along the second motion axis.

### CROSS REFERENCE TO RELATED APPLICATIONS

This application claims the benefit of German Application No. 102016214589.4 priority date of Aug. 5, 2016, the contents of which are herein incorporated by reference.

### FIELD OF INVENTION

The present invention relates to an injection moulding machine for producing a multiplicity of different injection mouldings.

### BACKGROUND

Injection moulding machines designed to produce injection mouldings are known from the prior art. For this purpose, the injection moulding machine known from the prior art has an injection unit for discharging a plasticized material via an outlet opening of the injection unit. Furthermore, the injection moulding machine known from the prior art has two injection mould halves, which are movable towards one another in the direction of a closed position and away from one another in the direction of an open position. Given an appropriate design, the injection moulding machine can produce a multiplicity of identical injection mouldings. If different injection mouldings are to be produced by means of the injection moulding machine known from the prior art, the injection mould halves must be replaced. For this purpose, the production process must be interrupted and the injection mould halves replaced in a complex process by appropriately trained personnel. A corresponding process of replacing the injection mould halves can take several hours.

### SUMMARY

It is an underlying object of the invention to provide an injection moulding machine by means of which different injection mouldings can be produced, wherein a pause in the production time of the injection moulding machine when changing production from a first injection moulding to a second injection moulding is to be reduced.

The object underlying the present invention is achieved by an injection moulding machine having the features of claim 1. Advantageous embodiments of the injection moulding machine are described in the dependent claims.

More precisely, the object underlying the present invention is achieved by an injection moulding machine for producing a multiplicity of different injection mouldings, wherein the injection moulding machine has an injection unit for discharging a plasticized material via at least one first outlet opening of the injection unit. The injection moulding machine furthermore has a first injection mould half and a second injection mould half, wherein the first injection mould half and/or the second injection mould half is/are movable towards one another in the direction of a closed position and away from one another in the direction of an open position along a first motion axis. The injection moulding machine according to the invention is characterized in that the first injection mould half and the second injection mould half each have a multiplicity of partial cavities, wherein, in the closed position, the partial cavities of the first injection mould half, together with corresponding partial cavities of the second injection mould half, form at least a multiplicity of different mould cavities corresponding to the multiplicity of injection mouldings to be produced, each of said cavities having an injection opening. In this case, the first and second injection mould halves are movable relative to the injection unit along a second motion axis, wherein the second motion axis is perpendicular to the first motion axis. The at least one first outlet opening of the injection unit can be brought into fluid communication with each injection opening of each mould cavity by moving/displacing/traversing the first and second injection mould halves along the second motion axis.

By means of the injection moulding machine according to the invention, it is possible to produce different injection mouldings, wherein a pause in the production time of the injection moulding machine when changing production from a first injection moulding to a second injection moulding is considerably reduced. This is because, to adapt the injection moulding machine to produce a different injection moulding, all that is required is to displace/traverse/move the first and second injection mould halves, whereupon the production process for the other injection moulding can be continued directly. By displacing the first and second injection mould halves, it is thus possible to inject plasticized material from the outlet opening into the corresponding mould cavities, enabling different injection mouldings to be produced. The complex process of removing the injection mould halves and replacing them with other injection mould halves is thus unnecessary.

There is fluid separation between the mould cavities formed by the partial cavities of the injection mould halves in the closed position, and therefore, when plasticized material is injected into the injection opening in fluid communication with the outlet opening of the injection moulding unit, only this mould cavity is filled with plasticized material.

The injection moulding unit is preferably also designed to plasticize the plasticizable material. The injection unit can also be referred to as an injection moulding unit. The injection moulding unit can have a hot-runner nozzle and/or a cold secondary runner, for example.

The injection mould halves can also be referred to as die halves. In the closed position of the injection mould halves, they are in contact with one another. The shapes of the mould cavities correspond to the shapes of the multiplicity of injection mouldings to be produced.

The first and second injection mould halves advantageously move synchronously.

The first motion axis can also be referred to as the direction of the opening and closing movement or as the first direction of motion.

The injection moulding machine is preferably designed in such a way that the injection unit has a plurality of mutually spaced first outlet openings, wherein mutually adjacent first outlet openings have a first spacing with respect to one another in the direction of the second motion axis, wherein the first injection mould half and the second injection mould half are designed in such a way that, in the closed position, they form a plurality of identically designed mould cavities corresponding to the plurality of first outlet openings. The injection openings of the identically designed mould cavities are arranged spaced apart, wherein mutually adjacent injection openings of identically designed mould cavities have the first spacing with respect to one another in the direction of the second motion axis. In a predetermined position of the first and second injection mould halves, the plurality of first outlet openings can be brought into fluid communication with all the injection openings of the identically designed mould cavities.

By appropriate design of the injection moulding machine, it is possible to produce a multiplicity of injection mouldings simultaneously, thus considerably reducing the production time required to produce a predetermined number of injection mouldings.

The injection unit can have two, three, four or more outlet openings, for example.

The identically designed mould cavities are formed by the partial cavities of the first and second injection mould halves. Consequently, the first injection mould half has a plurality of identically designed partial cavities corresponding to the plurality of outlet openings. The second injection mould half furthermore has a plurality of identically designed partial cavities corresponding to the plurality of outlet openings. In the closed position of the first and second injection mould halves, these partial cavities form the plurality of identically designed mould cavities corresponding to the plurality of outlet openings.

The correspondingly designed injection moulding machine consequently has the following features:
the injection unit has a plurality of outlet openings, which are arranged spaced apart along the second motion axis;
the first injection mould half and the second injection mould half are designed in such a way that, in the closed position, they form a plurality of identically designed mould cavities corresponding to the plurality of outlet openings;
the injection openings of the identically designed mould cavities are arranged spaced apart along the second motion axis; and
a spacing along the second motion axis of the injection openings of the mould cavities is identical with a spacing of the injection openings of the identically designed mould cavities, with the result that, in one position of the first and second injection mould halves, the plurality of outlet openings can be brought into fluid communication with all the injection openings of the identically designed mould cavities.

As a further preference, the injection moulding machine is designed in such a way that the injection unit has at least one second outlet opening, wherein the second outlet opening is spaced apart from the first outlet opening along a direction oriented perpendicularly to the first motion axis and perpendicularly to the second motion axis. In this case, an outlet direction of the plasticized material from the first outlet opening is opposed to an outlet direction of the plasticized material from the second outlet opening. The injection moulding machine has a third injection mould half and a fourth injection mould half, wherein the third injection mould half and/or the fourth injection mould half is/are movable towards one another in the direction of a closed position and away from one another in the direction of an open position along the first motion axis. The third injection mould half and the fourth injection mould half each have a multiplicity of partial cavities, wherein in the closed position, the partial cavities of the third injection mould half, together with corresponding partial cavities of the fourth injection mould half, form at least a multiplicity of different mould cavities corresponding to the multiplicity of injection mouldings to be produced, each of said cavities having an injection opening. The third and fourth injection mould halves are movable relative to the injection unit along the second motion axis, and the second outlet opening of the injection unit can be brought into fluid communication with each injection opening of each mould cavity by moving the third and fourth injection mould halves along the second motion axis.

By appropriate design of the injection moulding machine, it is possible to produce an even greater number of injection mouldings simultaneously, and there is thus a further considerable reduction in the production time required to produce a predetermined number of injection mouldings.

Here, the injection moulding machine is preferably designed in such a way that the injection unit has a plurality of mutually spaced second outlet openings, wherein mutually adjacent second outlet openings have a first spacing with respect to one another in the direction of the second motion axis. The third injection mould half and the fourth injection mould half are designed in such a way that, in the closed position, they form a plurality of identically designed mould cavities corresponding to the plurality of second outlet openings. The injection openings of the identically designed mould cavities are arranged spaced apart, wherein mutually adjacent injection openings of identically designed mould cavities have the first spacing with respect to one another in the direction of the second motion axis. In a predetermined position of the third and fourth injection mould halves, the plurality of second outlet openings can be brought into fluid communication with all the injection openings of the identically designed mould cavities.

By appropriate design of the injection moulding machine, it is possible to produce an even greater number of injection mouldings simultaneously, and there is thus a further considerable reduction in the production time required to produce a predetermined number of injection mouldings.

The injection unit can have two, three, four or more first and second outlet openings, respectively, for example.

The identically designed mould cavities are formed by the partial cavities of the first and second injection mould halves and by the partial cavities of the third and fourth injection mould halves. Consequently, the first, second, third and fourth injection mould halves have a plurality of identically designed partial cavities corresponding to the plurality of outlet openings. In the closed position of the first and second injection mould halves, these partial cavities form the plurality of identically designed mould cavities corresponding to the plurality of outlet openings. In the closed position of the third and fourth injection mould halves, these partial cavities form the plurality of identically designed mould cavities corresponding to the plurality of outlet openings.

According to a preferred embodiment, the injection moulding machine has at least one first holding device for holding the first injection mould half, wherein the first holding device is traversable/displaceable/movable between a release position and a fixing position. The first injection mould half is movable along the second motion axis in the release position of the first holding device, and the first holding device blocks a movement/displacement or traverse of the first injection mould half along the second motion axis in the fixing position of the first holding device.

According to a preferred embodiment, the injection moulding machine has at least one second holding device for holding the second injection mould half, wherein the second holding device is traversable/displaceable/movable between a release position and a fixing position. The second injection mould half is movable along the second motion axis in the release position of the second holding device, and the second holding device blocks a movement/displacement of the second injection mould half along the second motion axis in the fixing position of the second holding device.

According to a preferred embodiment, the injection moulding machine has at least one third holding device for holding the third injection mould half, wherein the third holding device is traversable/displaceable/movable between a release position and a fixing position. The third injection mould half is movable along the second motion axis in the release position of the third holding device, and the third holding device blocks a movement/displacement of the third injection mould half along the second motion axis in the fixing position of the third holding device.

According to a preferred embodiment, the injection moulding machine has at least one fourth holding device for holding the fourth injection mould half, wherein the fourth holding device is traversable/displaceable/movable between a release position and a fixing position. The fourth injection mould half is movable along the second motion axis in the release position of the fourth holding device, and the fourth holding device blocks a movement/displacement of the fourth injection mould half along the second motion axis in the fixing position of the fourth holding device.

The holding devices are preferably traversable along the third direction, which is oriented perpendicularly to the first motion axis and perpendicularly to the second motion axis.

The injection mould halves preferably have a rack-like lateral edge or toothing extending along the second motion axis and facing away from the injection openings. The holding devices preferably have a likewise rack-like lateral edge or toothing which faces the rack-like lateral edge. In the fixing position of the holding devices, the rack-like lateral edges of the holding devices engage in the corresponding rack-like lateral edges of the injection mould halves.

### BRIEF DESCRIPTION OF THE DRAWINGS

Further advantages, details and features of the invention will become apparent below from the illustrative embodiments explained. In particular:

FIG. 1: shows a disassembled injection moulding machine according to the present invention opened through 180°;

FIG. 2: shows an enlargement of the part of the injection moulding machine shown on the right in FIG. 1;

FIG. 3: shows a perspective view of an interior of the injection moulding machine;

FIG. 4: shows a perspective view of an injection unit of the injection moulding machine;

FIG. 5: shows a section through the injection unit shown in FIG. 4;

FIG. 6: shows an enlargement of the injection unit shown in FIG. 5 in the region of outlet openings of the injection unit; and

FIG. 7: shows an enlargement of the region of the injection moulding machine shown in FIG. 2.

### DETAILED DESCRIPTION

In the description which now follows, identical reference signs denote identical components or identical features, and therefore a description of a component given with reference to one figure also applies to the other figures, thus avoiding repeated description. Moreover, individual features which have been described in connection with one embodiment can also be used separately in other embodiments.

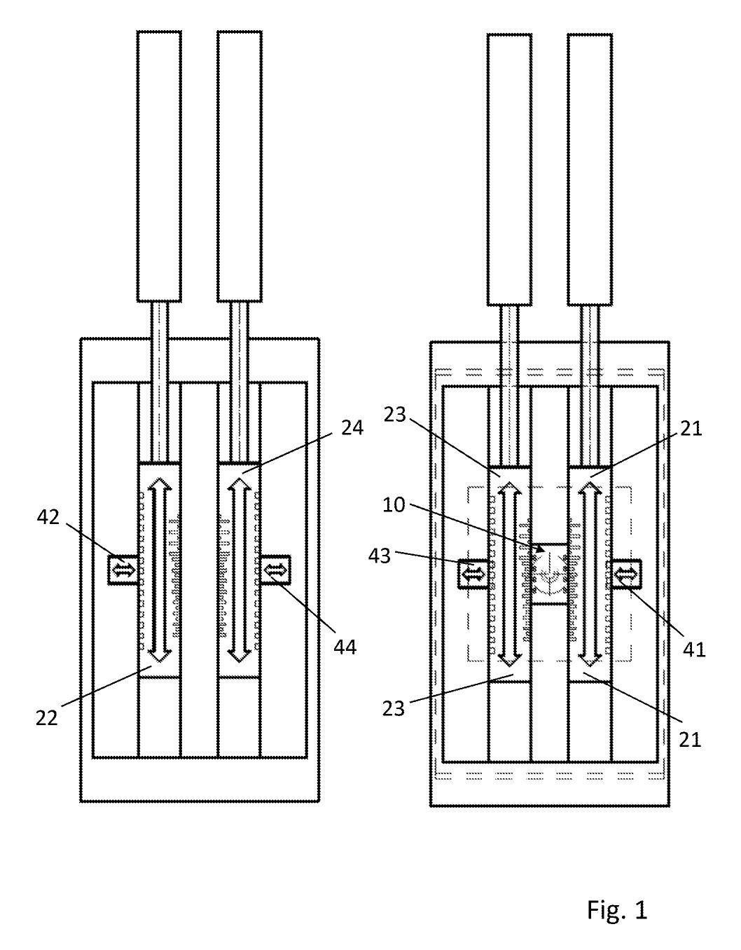

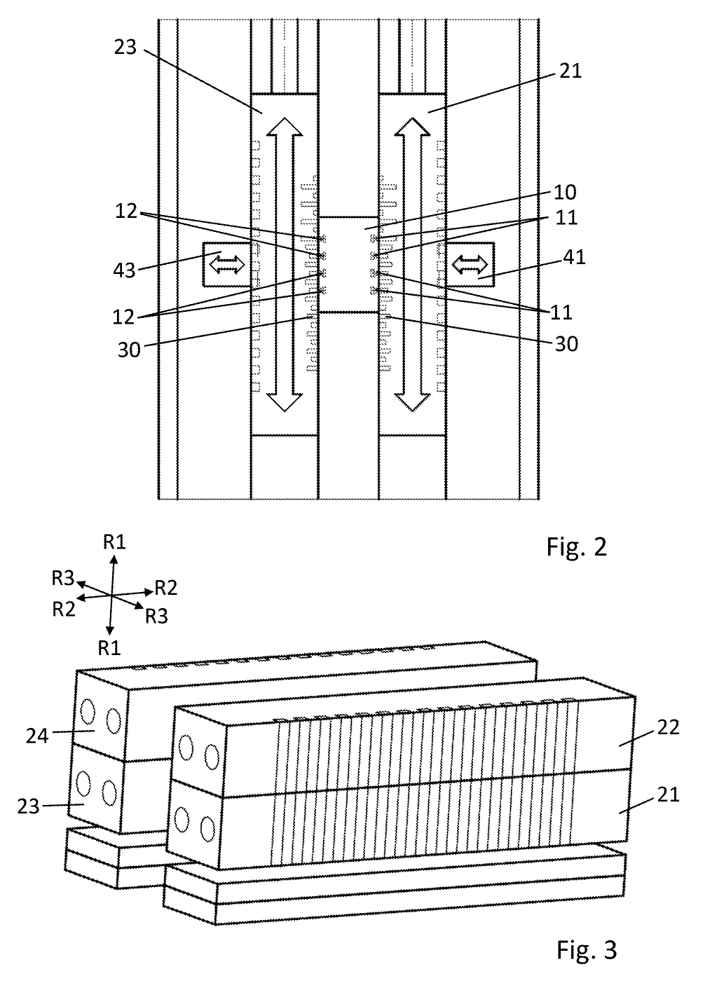

FIG. 1 shows an injection moulding machine according to the invention for producing a multiplicity of different injection mouldings in the disassembled and opened state. On the left-hand side, FIG. 1 shows an ejection side of the injection moulding machine and, on the right-hand side, it shows a nozzle side of the injection moulding machine. The nozzle side of the injection moulding machine is shown on an enlarged scale in FIG. 2. It is apparent that the injection moulding machine has, on the nozzle side thereof, an injection unit 10 for discharging plasticized material via first outlet openings 11 and second outlet openings 12. The first outlet openings 11 are arranged on the right-hand side in the injection unit 10, and the second outlet openings 12 are arranged on the injection unit 10 on the left-hand side of the injection unit 10 in the illustration according to FIGS. 1 and 2. In the illustrative embodiment shown, the injection unit 10 has four first outlet openings 11 and four second outlet openings 12.

In the embodiment shown, the injection moulding machine has four injection mould halves, namely a first injection mould half 21, a second injection mould half 22, a third injection mould half 23 and a fourth injection mould half 24. Each of the injection mould halves 21, 22, 23, 24 has a multiplicity of partial cavities 30.

As can be seen from FIG. 3, the first injection mould half 21 and the second injection mould half 22 are arranged opposite one another. Moreover, the third injection mould half 23 and the fourth injection mould half 24 are likewise arranged opposite one another. The first injection mould half 21 and/or the second injection mould half 22 is/are movable towards one another in the direction of a closed position shown in FIG. 3 and away from one another in the direction of an open position along a first direction of motion R1. The third injection mould half 23 and/or the fourth injection mould half 24 is/are likewise movable towards one another in the direction of a closed position and away from one another in the direction of an open position along the first direction of motion R1. In the open position, injection mouldings produced can be ejected from the injection moulding machine. The third injection mould half 23 and/or the fourth injection mould half 24 is/are likewise movable towards one another in the direction of a closed position and away from one another in the direction of an open position along the first direction of motion R1.

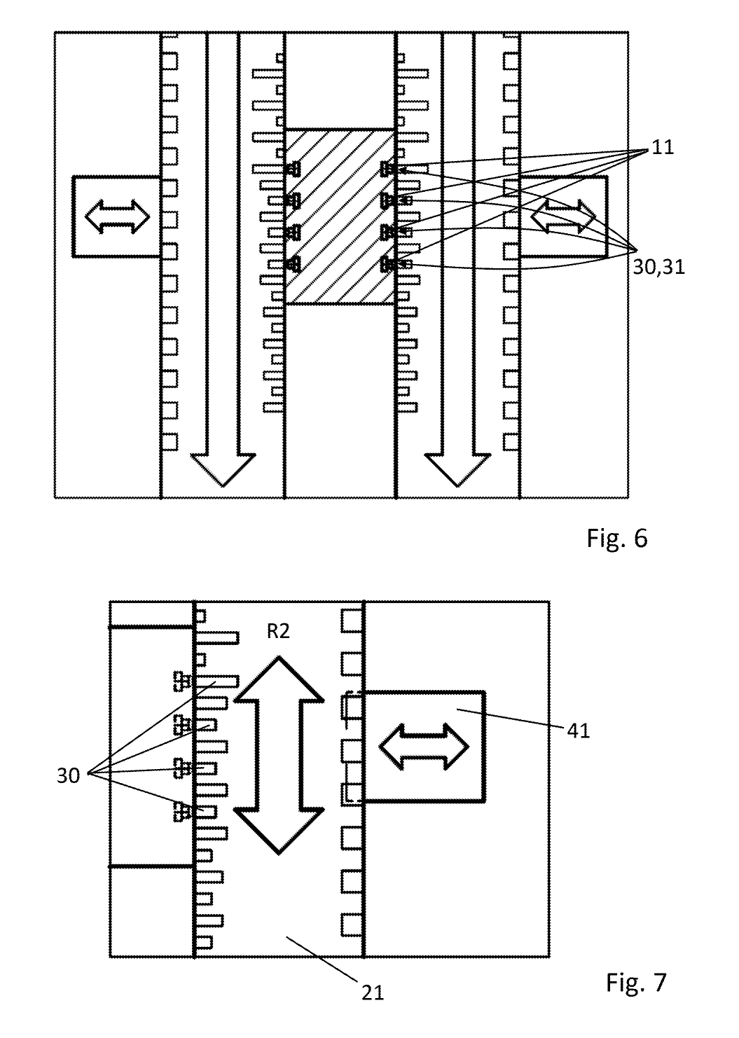

In the closed position, the partial cavities 30 of the first injection mould half 21, together with corresponding partial cavities 30 of the second injection mould half 22, form at least a multiplicity of different mould cavities corresponding to the multiplicity of injection mouldings to be produced. Each of the mould cavities has an injection opening 31 (see FIG. 6). Moreover, in the closed position of the third injection mould half 23 and fourth injection mould half 24, the partial cavities 30 of the third injection mould half 23, together with corresponding partial cavities 30 of the fourth injection mould half 24, form at least a multiplicity of different mould cavities corresponding to the multiplicity of injection mouldings to be produced, each of said cavities likewise having an injection opening 31.

In the illustrative embodiment shown, in which there are in each case four first outlet openings 11 and four second outlet openings 12 arranged on each side of the injection unit 10, the partial cavities 30 of the first injection mould half 21, together with the partial cavities 30 of the second injection mould half 22, are four times greater in number than the multiplicity of injection mouldings to be produced. The partial cavities 30 of the third injection mould half 23, together with the partial cavities 30 of the fourth injection mould half 24, are likewise four times greater in number than the multiplicity of injection mouldings to be produced.

If the injection moulding machine is provided for the production of ten different injection mouldings, for example, the injection mould halves 21, 22, 23, 24 each have forty partial cavities. In this case, four partial cavities of the forty partial cavities are of identical design in each case. Thus, the first and second injection mould halves 21, 22, each situated in the closed position, then form forty mould cavities, wherein four mould cavities are of identical design in each case. Thus, the first injection mould half 21, together with the second injection mould half 22, in each case forms ten different mould cavities implemented four times over. The same applies to the third and fourth injection mould halves 23, 24 situated in the closed position, which likewise have forty mould cavities in the closed position, wherein four mould cavities are of identical design to one another in each case. Thus, the third injection mould half 23, together with the fourth injection mould half 34, in each case forms ten different mould cavities implemented four times over.

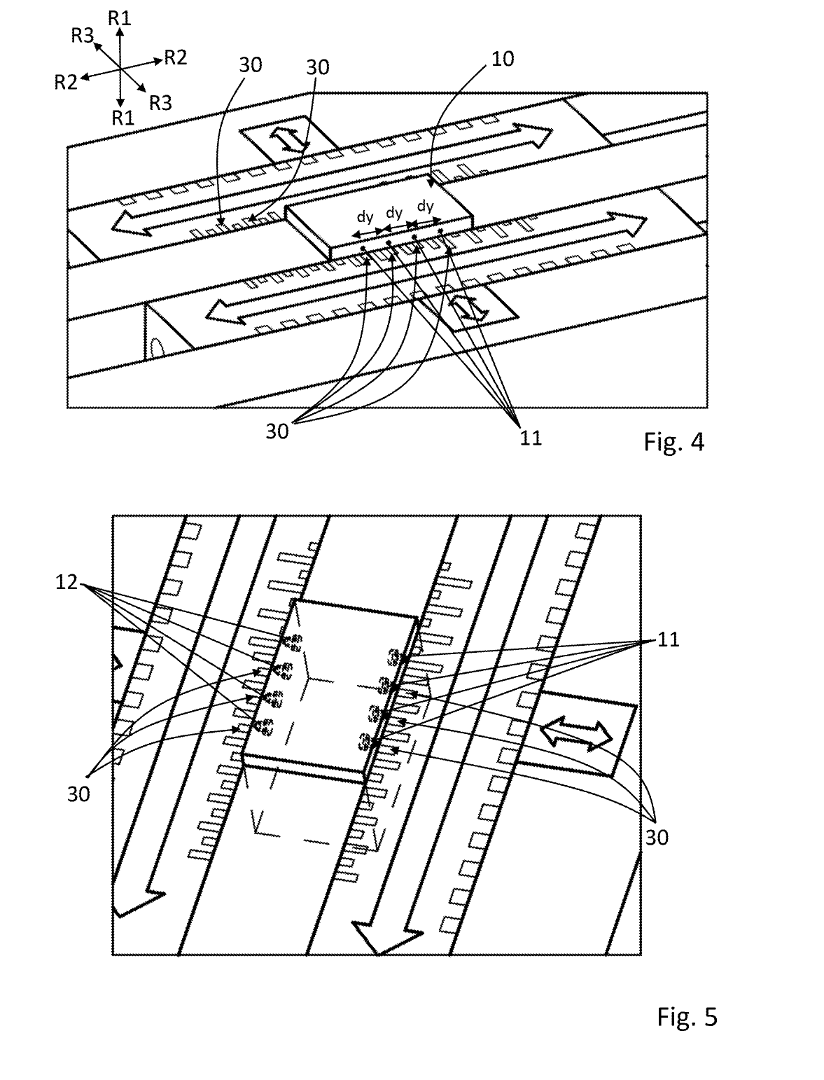

The first and second injection mould halves 21, 22 are movable relative to the injection unit 10 along a second motion axis R2 (see FIGS. 3 and 4). Here, the second motion axis R2 is aligned perpendicularly to the first motion axis R1. The third and fourth injection mould halves 23, 24 are also movable relative to the injection unit 10 along the second motion axis R2. From FIGS. 4 to 6, it can be seen that the first outlet openings 11 and the second outlet openings 12 of the injection unit 10 can be brought into fluid communication with each injection opening 31 of each mould cavity by moving the injection mould halves along the second motion axis R2.

From FIGS. 4 and 6, it can be seen that the first outlet openings 11 are spaced apart. Here, two mutually adjacent first outlet openings 11 have a first spacing dy in the direction of the second motion axis R2.

The first injection mould half 21 and the second injection mould half 22 are designed in such a way that, in the closed position, they form a plurality of identically designed mould cavities corresponding to the plurality of first outlet openings 11. The injection openings 31 of the identically designed mould cavities are arranged spaced apart, wherein mutually adjacent injection openings 31 of identically designed mould cavities have the first spacing dy with respect to one another in the direction of the second motion axis R2. In a predetermined position of the first and second injection mould halves 21, 22, as shown in FIGS. 2 and 4 to 6 for example, all the first outlet openings 11 are in fluid communication with all the injection openings 31 of the identically designed mould cavities.

The second outlet openings 12 are likewise spaced apart. In this case, two mutually adjacent second outlet openings 12 have a first spacing dy with respect to one another in the direction of the second motion axis R2.

The third injection mould half 23 and the fourth injection mould half 24 are designed in such a way that, in the closed position, they form a plurality of identically designed mould cavities corresponding to the plurality of second outlet openings 12. The injection openings 31 of the identically designed mould cavities are arranged spaced apart, wherein mutually adjacent injection openings 31 of identically designed mould cavities have the first spacing dy with respect to one another in the direction of the second motion axis R2. In a predetermined position of the third and fourth injection mould halves 23, 24, as can be seen in from FIGS. 5 and 6 for example, all the second outlet openings 12 are in fluid communication with all the injection openings 31 of the identically designed mould cavities.

From FIG. 5, in particular, it can be seen that the second outlet openings 12 are spaced apart from the first outlet openings 11 in direction R3. In this case, an outlet direction of the plasticized material from the first outlet openings 11 is opposed to an outlet direction of the plasticized material from the second outlet openings 12.

The injection moulding machine furthermore has holding devices 41, 42, 43, 44 for holding the injection mould halves 21, 22, 23, 24. In this case, the first holding device 41 is designed to hold the first injection mould half 21. The second holding device 42 is designed to hold the second injection mould half 22. The third holding device 43 is designed to hold the third injection mould half 23. The fourth holding device 44 is designed to hold the fourth injection mould half 44. The respective holding devices 41-44 are traversable between a release position and a fixing position. In the release position of the respective holding devices 41-44, the corresponding injection mould halves 21-24 are movable along the second motion axis R2, whereas, in the fixing positions of the holding devices 41-44, the holding devices 41-44 block a movement of the injection mould halves 21-24 along the second motion axis R2. In this case, the holding devices 41-44 are traversable along the third direction R3.

The respective injection mould halves 21-24 have rack-like lateral edges extending along the second motion axis R2 and facing away from the injection openings 31. The respective holding devices 41-44 each have a likewise rack-like lateral edge or toothing which face the rack-like lateral edge of the injection mould halves. In the fixing position of the holding devices 41-44, the rack-like lateral edges of the holding devices 41-44 engage in the corresponding rack-like lateral edges of the injection mould halves 21-24.

### LIST OF REFERENCE SIGNS

10 injection unit
11 first outlet opening
12 second outlet opening
dy first spacing between two adjacent outlet openings
21 first injection mould half
22 second injection mould half
23 third injection mould half
24 fourth injection mould half
30 partial cavity
31 injection opening (of a mould cavity)
41 first holding device
42 second holding device
43 third holding device
44 fourth holding device
R1 first motion axis/direction of motion/direction of opening and closing
R2 second motion axis
R3 third direction

1. An injection moulding machine for producing a multiplicity of different injection mouldings, the injection moulding machine comprising:
an injection unit for discharging a plasticized material via at least one first outlet opening of the injection unit;
a first injection mould half and a second injection mould half, wherein the first injection mould half and/or the second injection mould half is/are movable towards one another in the direction of a closed position and away from one another in the direction of an open position along a first motion axis;
wherein the first injection mould half and the second injection mould half each have a multiplicity of partial cavities;
in the closed position, the partial cavities of the first injection mould half, together with corresponding partial cavities of the second injection mould half, form at least a multiplicity of different mould cavities corresponding to the multiplicity of injection mouldings to be produced, each of said cavities having an injection opening;
the first and second injection mould halves are movable relative to the injection unit along a second motion axis, wherein the second motion axis is perpendicular to the first motion axis; and
the at least one first outlet opening of the injection unit can be brought into fluid communication with each injection opening of each mould cavity by moving the first and second injection mould halves along the second motion axis.

2. The injection moulding machine of claim 1, wherein:
the injection unit has a plurality of mutually spaced first outlet openings, wherein mutually adjacent first outlet openings have a first spacing with respect to one another in the direction of the second motion axis;
the first injection mould half and the second injection mould half are designed in such a way that, in the closed position, they form a plurality of identically designed mould cavities corresponding to the plurality of first outlet openings;
the injection openings of the identically designed mould cavities are arranged spaced apart, wherein mutually adjacent injection openings of identically designed mould cavities have the first spacing with respect to one another in the direction of the second motion axis; and
in a predetermined position of the first and second injection mould halves, the plurality of first outlet openings can be brought into fluid communication with all the injection openings of the identically designed mould cavities.

3. The injection moulding machine of claim 1, wherein:
the injection unit has at least one second outlet opening;
the second outlet opening is spaced apart from the first outlet opening along a direction oriented perpendicularly to the first motion axis and perpendicularly to the second motion axis;
an outlet direction of the plasticized material from the first outlet opening is opposed to an outlet direction of the plasticized material from the second outlet opening;
the injection moulding machine has a third injection mould half and a fourth injection mould half;
the third injection mould half and/or the fourth injection mould half is/are movable towards one another in the direction of a closed position and away from one another in the direction of an open position along the first motion axis;
the third injection mould half and the fourth injection mould half each have a multiplicity of partial cavities;
in the closed position, the partial cavities of the third injection mould half, together with corresponding partial cavities of the fourth injection mould half, form at least a multiplicity of different mould cavities corresponding to the multiplicity of injection mouldings to be produced, each of said cavities having an injection opening;
the third and fourth injection mould halves are movable relative to the injection unit along the second motion axis; and
the second outlet opening of the injection unit can be brought into fluid communication with each injection opening of each mould cavity by moving the third and fourth injection mould halves along the second motion axis.

4. The injection moulding machine of claim 3, wherein:
the injection unit has a plurality of mutually spaced second outlet openings, wherein mutually adjacent second outlet openings have a first spacing with respect to one another in the direction of the second motion axis;
the third injection mould half and the fourth injection mould half are designed in such a way that, in the closed position, they form a plurality of identically designed mould cavities corresponding to the plurality of second outlet openings;
the injection openings of the identically designed mould cavities are arranged spaced apart, wherein mutually adjacent injection openings of identically designed mould cavities have the first spacing with respect to one another in the direction of the second motion axis;
in a predetermined position of the third and fourth injection mould halves, the plurality of second outlet openings can be brought into fluid communication with all the injection openings of the identically designed mould cavities.

5. The injection moulding machine of claim 1, wherein:
the injection moulding machine has at least one first holding device for holding the first injection mould half;
the first holding device is traversable between a release position and a fixing position;
the first injection mould half is movable along the second motion axis in the release position of the first holding device; and
the first holding device blocks a movement of the first injection mould half along the second motion axis in the fixing position of the first holding device.

6. The injection moulding machine of claim 1, wherein:
the injection moulding machine has at least one second holding device for holding the second injection mould half;
the second holding device is traversable between a release position and a fixing position;
the second injection mould half is movable along the second motion axis in the release position of the second holding device; and
the second holding device blocks a movement of the second injection mould half along the second motion axis in the fixing position of the second holding device.

7. The injection moulding machine of claim 3 wherein:
the injection moulding machine has at least one third holding device for holding the third injection mould half;
the third holding device is traversable between a release position and a fixing position;
the third injection mould half is movable along the second motion axis in the release position of the third holding device; and
the third holding device blocks a movement of the third injection mould half along the second motion axis in the fixing position of the third holding device.

8. The injection moulding machine of claim 3 wherein:
the injection moulding machine has at least one fourth holding device for holding the fourth injection mould half;
the fourth holding device is traversable between a release position and a fixing position;
the fourth injection mould half is movable along the second motion axis in the release position of the fourth holding device; and
the fourth holding device blocks a movement of the fourth injection mould half along the second motion axis in the fixing position of the fourth holding device.

9. The injection moulding machine of claim 2, wherein:
the injection unit has at least one second outlet opening;
the second outlet opening is spaced apart from the first outlet opening along a direction oriented perpendicularly to the first motion axis and perpendicularly to the second motion axis;
an outlet direction of the plasticized material from the first outlet opening is opposed to an outlet direction of the plasticized material from the second outlet opening;
the injection moulding machine has a third injection mould half and a fourth injection mould half;
the third injection mould half and/or the fourth injection mould half is/are movable towards one another in the direction of a closed position and away from one another in the direction of an open position along the first motion axis;
the third injection mould half and the fourth injection mould half each have a multiplicity of partial cavities;
in the closed position, the partial cavities of the third injection mould half, together with corresponding partial cavities of the fourth injection mould half, form at least a multiplicity of different mould cavities corresponding to the multiplicity of injection mouldings to be produced, each of said cavities having an injection opening;
the third and fourth injection mould halves are movable relative to the injection unit along the second motion axis; and
the second outlet opening of the injection unit can be brought into fluid communication with each injection opening of each mould cavity by moving the third and fourth injection mould halves along the second motion axis (R2).

10. The injection moulding machine of claim 9, wherein:
the injection unit has a plurality of mutually spaced second outlet openings, wherein mutually adjacent second outlet openings have a first spacing with respect to one another in the direction of the second motion axis;
the third injection mould half and the fourth injection mould half are designed in such a way that, in the closed position, they form a plurality of identically designed mould cavities corresponding to the plurality of second outlet openings;
the injection openings of the identically designed mould cavities are arranged spaced apart, wherein mutually adjacent injection openings of identically designed mould cavities have the first spacing with respect to one another in the direction of the second motion axis;
in a predetermined position of the third and fourth injection mould halves, the plurality of second outlet openings can be brought into fluid communication with all the injection openings of the identically designed mould cavities.

11. The injection moulding machine of claim 10, wherein:
the injection moulding machine has at least one first holding device for holding the first injection mould half;
the first holding device is traversable between a release position and a fixing position;
the first injection mould half is movable along the second motion axis in the release position of the first holding device; and
the first holding device blocks a movement of the first injection mould half along the second motion axis in the fixing position of the first holding device.

12. The injection moulding machine of claim 11, wherein:
the injection moulding machine has at least one second holding device for holding the second injection mould half;
the second holding device is traversable between a release position and a fixing position;
the second injection mould half is movable along the second motion axis in the release position of the second holding device; and
the second holding device blocks a movement of the second injection mould half along the second motion axis in the fixing position of the second holding device.

13. The injection moulding machine according to claim 12, wherein:
the injection moulding machine has at least one third holding device for holding the third injection mould half;
the third holding device is traversable between a release position and a fixing position;
the third injection mould half is movable along the second motion axis in the release position of the third holding device; and
the third holding device blocks a movement of the third injection mould half along the second motion axis in the fixing position of the third holding device.
